(19) United States
(12) Patent Application Publication
(10) Pub. No.: US 2020/0125974 A1
(43) Pub. Date: Apr. 23, 2020

(54) METHOD FOR DETERMINING A PROCESS VARIABLE WITH A CLASSIFIER FOR SELECTING A MODEL FOR DETERMINING THE PROCESS VARIABLE

(71) Applicant: Endress+Hauser Conducta GmbH+Co. KG, Gerlingen (DE)

(72) Inventors: Thomas Alber, Stuttgart (DE); Dieter Waldhauser, Durach (DE); Philipp Leufke, Rheinfelden (DE); Markus Kilian, Merzhausen (DE); Tobias Brengartner, Emmendingen (DE); Sergey Lopatin, Lorrach (DE); Rebecca Page, Basel (CH); Ruediger Frank, Haigerloch (DE)

(21) Appl. No.: 16/653,309

(22) Filed: Oct. 15, 2019

(30) Foreign Application Priority Data
Oct. 18, 2018 (DE) 10 2018 125 907.7

(51) Int. Cl. G06N 5/04; G06N 20/00

(52) U.S. Cl. CPC G06N 5/04; G06N 20/00

(57) ABSTRACT

The present disclosure relates to a method for determining at least one process variable of a medium, including steps of recording a sensor signal from a field device and determining a selected model from a set of at least two different models by means of a classifier. Each of the models is used for determining the process variable based at least on the sensor signal. The classifier is designed to select the selected model. The method also includes a step of determining the process variable based at least on the selected model and the sensor signal.

### CROSS-REFERENCE TO RELATED APPLICATION

The present application is related to and claims the priority benefit of German Patent Application No. 10 2018 125 907.7, filed on Oct. 18, 2018, the entire contents of which are incorporated herein by reference.

### TECHNICAL FIELD

The present disclosure relates to a method for determining a process variable of a medium with a classifier for selecting a model for determining the process variable. The present disclosure also relates to a computer program for determining the process variable, and to a computer program product with a corresponding computer program.

### BACKGROUND

Field devices for determining, monitoring, and/or influencing various process variables are frequently used in process and/or automation technology. Examples of such field devices or measuring devices are fill level measuring devices, flow measuring devices, pressure and temperature measuring devices, pH and/or pH redox potential measuring devices, as well as conductivity measuring devices, which serve to detect the respective corresponding process variables such as a fill level, a flow rate, the pressure, the temperature, a pH value, a redox potential, or a conductivity. The respective underlying measuring principles are sufficiently known from the prior art and are not listed individually at this point. Flow-measuring devices are, in particular, Coriolis, ultrasound, vortex, thermal, and/or magnetically inductive flow-measuring devices. Fill-level measuring devices are, in particular, microwave fill-level measuring devices, ultrasonic fill-level measuring devices, time domain reflectometry fill-level measuring devices (TDR), radiometric fill-level measuring devices, capacitive fill-level measuring devices, conductive fill-level measuring devices, and/or temperature-sensitive fill-level measuring devices. By contrast, pressure measuring devices are preferably what are known as absolute, relative, or differential pressure devices, whereas temperature measuring devices frequently have thermal elements or temperature-dependent resistors for determining the temperature.

Within the scope of the present application, all devices that are arranged on the field level, i.e., are used close to the process and provide or process process-relevant information, are, in principle, called field devices. In addition to sensors and actuators, units that are directly connected to a field bus and used for communication with a control unit, such as a control system, e.g., remote IO's, gateways, linking devices, and wireless adapters or radio adapters, are also generally called field devices. The companies of the Endress+Hauser Group produce and distribute a large variety of such field devices.

With regard to a particular process variable, many different competing models or measurement principles are often available for their determination, as has already been mentioned in part. The different measurement principles then often have different measurement accuracies for different applications, including different media, or are suitable to different degrees for various reasons.

This relates not only to the instance in which one and the same process variable can be determined by means of different measuring principles. Rather, for a multitude of applications it is the case that, for different applications, different models are used for one and the same measuring device in order to be able to ensure a high measuring accuracy over a wide range of applications. In this instance, the model to be used at the measuring device must then often be selected manually, depending on the application.

In this context, different uses or applications relate to the determination of a process variable for different media with different physical and/or chemical properties.

### SUMMARY

The present disclosure is based on the object of increasing the field of use or application for a field device in an efficient manner.

This object is achieved via the method, computer program and computer program product of the present disclosure.

The method for determining at least one process variable of a medium includes steps of recording a sensor signal from a field device and determining a selected model from a set of at least two different models by means of a classifier. Each of the models serves to determine the process variable at least on the basis of the sensor signal, and the classifier is designed to select the selected model. The method also includes a step of determining the process variable based at least on the selected model and the sensor signal.

The classifier accordingly serves for the selection, such as the automatic selection, of the selected model which is to be used for determining the value for the process variable. The models are stored, for example, in a memory unit of a computing unit of a field device, or in a higher-level unit.

Measurements in which manual, process-specific inputs are required, thus in which a matching model is to be selected depending on the application, can advantageously be markedly simplified via this measure. The achievable measurement accuracy can similarly be markedly increased.

In one embodiment, the classifier is designed to learn the selection of the selected model. The classifier is accordingly a unit equipped with artificial intelligence and learns to select the selected model. An intelligent selection of the model is therefore involved. The machine learning process that is carried out by the classifier can be both a supervised and an unsupervised learning process.

In another embodiment, the classifier is trained offline and/or online. An offline training is understood to mean training before the implementation of the method, thus before the method is used for determining a value for a process variable. In principle, this involves training under laboratory conditions. Instead or in addition, however, the classifier can also be trained online, i.e. in the continuous process or during the implementation of the method in the process.

In addition, depending on whether a training is carried out online or offline, different types of training are particularly advantageous. In an online training, for example, the method of self-organized maps may be used. In an offline training, for example, the method of time series analysis can also be used. This method is comparatively complex and thus, for example, is possibly less well suited to online training.

In one embodiment of the method, the classifier is designed to take into account at least one influencing variable when selecting the selected model. This influencing variable may, for example, be a process and/or environmental parameter, for example a physical or chemical property of the medium and/or the environment.

It is particularly advantageous if the influencing variable is the sensor signal or a variable derived from the sensor signal. The variable derived from the sensor signal can in turn be, for example, a value for the process variable.

In one embodiment of the method, a data set comprising at least one input variable and one output variable associated with the input variable is used to create a mapping, such as a numerical mapping, based on which mapping the classifier determines the selected model. This embodiment may be suitable if the classifier runs through a supervised learning process.

In a further embodiment of the method, a feature vector is determined, wherein the classifier is designed to select the selected model based on the feature vector.

In this regard, it may be advantageous if a first and a second classifier are used, wherein the first classifier serves for implementing a feature extraction and/or for creating a feature vector, and wherein a second classifier serves to select the selected model based on the feature vector. The embodiment with a first and a second classifier may be suitable for an at least partially unsupervised learning process of the classifier. The first classifier learns the extraction of the feature vector in an unsupervised learning process, whereas the second classifier can operate in a supervised learning process, for example.

Another embodiment includes determining a classification quality with respect to the selection of the selected model. With this embodiment, for example, a check of the decisions of the classifier with regard to the selection of the selected model is possible. A classification quality may be determined on the basis of a Softmax function.

In this instance, it may be advantageous if a statement about the classification quality is made on the basis of a probability with which the classifier selects the selected model.

It may also be advantageous if a change of the classifier from a first to a second selected model is detected. Among other things, this allows a historical consideration of the process. A correlation of the decisions of the classifier with the process is possible. In this way, among other things a probability density or frequency distribution with regard to the selection of the respective model for certain process variables can be determined.

Finally, it may be advantageous if an alternating frequency between the two selected models, or a time interval during which the first or second selected model is used, is determined.

A further embodiment of the method includes the field device being a field device for determining and/or monitoring a turbidity, a flow rate, or a fill level of a medium, or for determining a concentration of at least one substance contained in a medium, such as, for example, a solid, an alcohol, or a salt.

The object forming the basis of the present disclosure is further achieved by a computer program for determining at least one process variable of a medium, with computer-readable program code elements that, when executed on a computer, cause the computer to execute at least one embodiment of the method according to the present disclosure.

The object underlying the present disclosure is likewise achieved by a computer program product having a computer program according to the present disclosure and at least one computer-readable medium on which the at least the computer program is stored.

It is noted that the embodiments described in conjunction with the method according to the present disclosure also apply, mutatis mutandis, to the computer program according to the present disclosure and to the computer program product.

### BRIEF DESCRIPTION OF THE DRAWINGS

The present disclosure is explained in greater detail with reference to the following figures.

FIG. 1 (comprising FIGS. 1a and 1b) shows a flowchart for illustration of the method according to the present disclosure;

FIG. 2 (comprising FIGS. 2a, 2b and 2c) illustrates a possible application in conjunction with the determination of a fill level according to the reflectometric measuring principle;

FIG. 3 (comprising FIGS. 3a, 3b and 3c) illustrates a possible application in conjunction with the determination of a turbidity of a medium; and

FIG. 4 (comprising FIGS. 4a, 4b, 4c and 4d) illustrates a possible application in conjunction with the determination of an alcohol content.

### DETAILED DESCRIPTION

In the Figures, identical elements are respectively provided with the same reference characters.

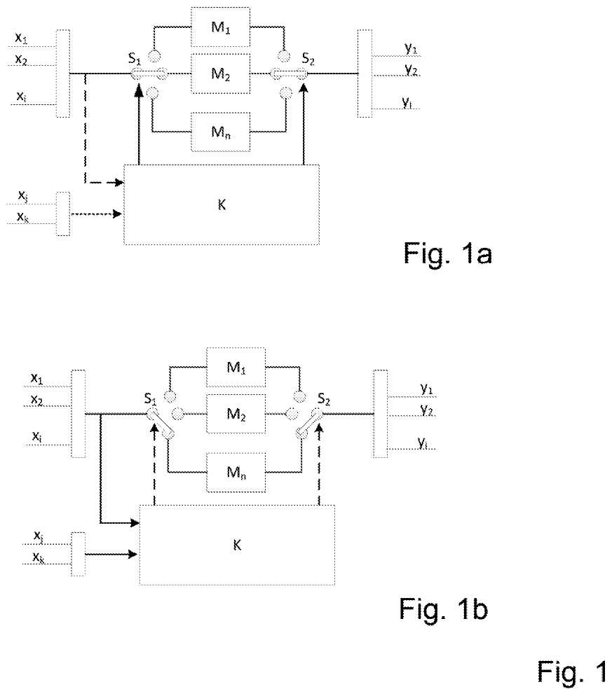

The method according to the present disclosure is schematically depicted in FIG. 1.

The method can, for example, be implemented in an electronic system of a field device 1, 4 (shown in later Figures) or in a higher-level unit. The electronic system comprises a memory unit, which is likewise not shown separately, in which different models M₁-Mₙ for determining the process variable y are stored on the basis of a sensor signal x received from a sensor unit (not shown) of the field device 1, 4.

Respectively received from the sensor unit is/are a sensor signal or a plurality of sensor signals x₁-xᵢ for which the process variable y₁-yᵢ is respectively to be determined. The various models M₁-Mₙ are thereby available for determining the process variable y. The classifier K according to the present disclosure then serves to determine and select a selected model (here M₂) from the set of models M₁-Mₙ. This selection is illustrated in FIG. 1 by the arrows and the two switching elements S₁ and S₂. In the instance of FIG. 1a, the model M₂, by means of which the process variable y₂ is determined at least from the sensor signal x₂, has been selected by the classifier K.

Optionally, one or more influencing variables can be made available to the classifier K, as indicated by the dashed arrows. In the present instance, these are e.g. the sensor signals x₁-xᵢ, as well as the further influencing variables xⱼ and xₖ.

The different models M₁-Mₙ can respectively be used to determine the process variable y₁-yᵢ based on the sensor signals x₁-xᵢ. The models M₁-Mₙ may, for example, relate to different measurement principles or different configurations in the process, for example different fields of use and/or application. For example, the different models M₁-Mₙ may also be at least partially mutually exclusive, so that certain models are not applicable to certain circumstances. In the simplest instance, the respectively selected model M₂ remains the same for a predeterminable duration of a specific process. However, it is also conceivable that, during continuous operation, process and/or ambient conditions change in such a way that a change of the selected model M₂ by the classifier K is to be performed continuously, periodically, or selectively. For example, in the instance of FIG. 1b the model Mₙ, by means of which the process variable yᵢ is determined at least from the sensor signal xᵢ, has been selected by the classifier K.

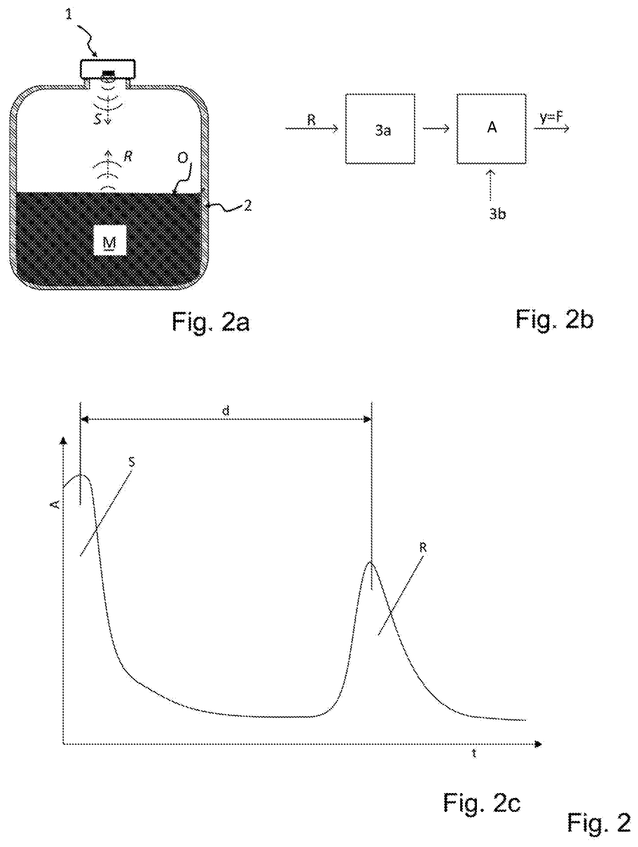

A possible application of the method according to the present disclosure with regard to the contactless determination of a fill level F of a medium M as process variable y is illustrated by the run-time-based fill level measurement method known per se from the prior art, as illustrated in FIG. 2. Corresponding field devices are produced by the applicant in many different embodiments and are sold under the designations Micropilot, Levelflex, or Prosonic, for example.

The measuring principle is illustrated schematically in FIG. 2a. A transmission signal S is reflected against a surface O of a medium M located in a container 2, and the received echo signal R is then evaluated with respect to the fill level F of the medium M. The signal evaluation is shown in FIG. 2b. Since, as a rule, different spurious echo signals are superimposed on the fill level-dependent echo signal, the received echo signal R first needs to be appropriately processed further. In order to be able to respectively extract the fill level-dependent echo signal from the reflected echo signal R, a signal transformation 3a is therefore often implemented in frequency space, for example a Fast Fourier Transformation (FFT). What are known as envelopes are subsequently evaluated by means of respective algorithms A provided for this purpose, on the basis of which the fill level F can be determined. (An example of an envelope is shown in FIG. 2c, including amplitude A over time t, and distance d.)

In order to allow an optimally precise determination of the fill level F, the respectively used algorithms A must be appropriately parameterized 3b for the respective process or the respective application. This parameterization 3b, or the selection and specification of the parameters, often takes place manually according to the prior art. For example, a maximum filling speed and/or emptying speed of the container 2 are specified for the precise tracking of the fill level-dependent echo signal. For precise determination of the fill level F, various data are in turn required regarding the medium M, including the the dielectric constant, and for the surface behavior of the medium M within the container, for example information regarding turbulence or foam formation in the area of the surface O. The parameterization 3b is accordingly highly application-specific and must be selected appropriately for each new application. This is associated with a high cost.

In relation to the present disclosure, the different envelopes, algorithms A, or even different parameter sets serve as different models M₁-Mₙ. The classifier K serves for the intelligent selection of the matching model for determining the process variable y=F on the basis of the sensor signals x, which in this instance are provided by the echo signals R. In this respect, it is conceivable that the classifier K selects at least one parameterization 3b for a parameter from a plurality of parameter values based on one or more envelope(s).

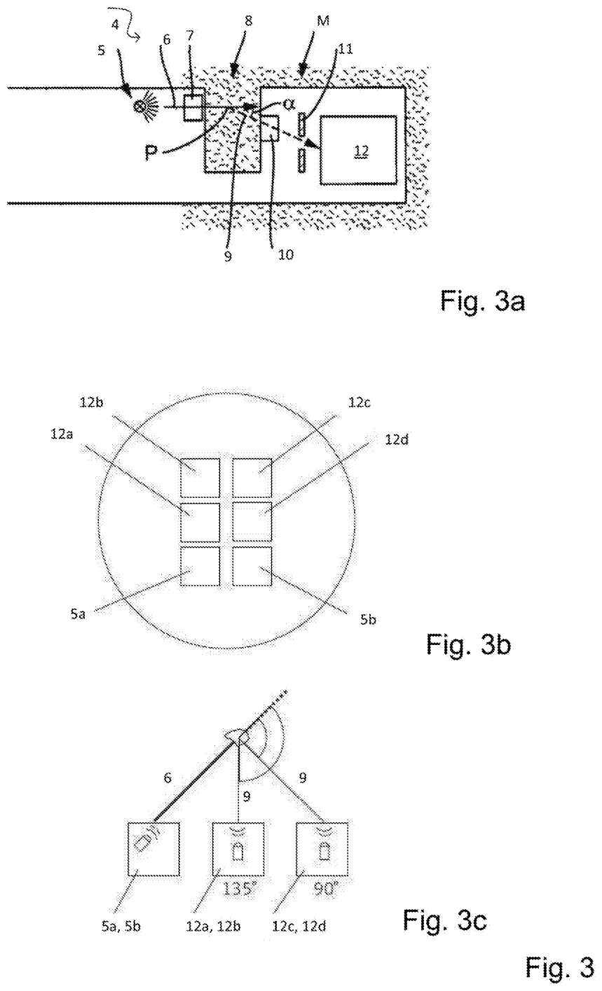

Another example of an application of the method according to the present disclosure relates to a turbidity sensor 4, likewise known from the prior art, for determining a turbidity of a medium M, as illustrated in FIG. 3. Such sensors 4 can additionally be used for determining the substance concentration of an undissolved solid CF, for example for determining the substance concentration of various sludges, such as in sewage treatment plants. For example, what are known as thin slurries, activated sludges, surplus activated sludges, or also digested sludges are known in this context. For each type of sludge, a separate suitable model is provided by means of which the substance concentration of the solid y=CF can be determined on the basis of a sensor signal x of the turbidity sensor 4.

Turbidity sensors are also produced by the applicant in various embodiments and are sold under the name Turbimax, for example. A turbidity sensor 4 based on the measurement principle of scattered light measurement is shown in FIG. 3a. Starting from the light source 5, transmitted light 6 (solid line) is radiated across a window 7 that is transparent to the transmitted light 6 into a measuring chamber 8 containing the medium M. There, the transmitted light 6 is scattered at a scattering point P at a measurement angle α, or is converted into received light 9 (dashed line). The received light 9 in turn passes across a window 10, which is transparent to the received light 9, via a diaphragm 11, to a detector 12 and is a measure of the turbidity of the medium M.

In the instance of the quadruple-beam alternating light method, as illustrated in FIGS. 3b and 3c the sensor 4 has two light sources 5a, 5b and four detectors 12a-12d for redundant detection of the received light 9 or scattered light. Two of the detectors 12c and 12d may serve for detecting 90° scattered light; the other two 12a and 12b may serve for detecting 135° scattered light. FIG. 3b thereby shows a schematic front view of the sensor 4, and FIG. 3c shows a side view.

Before starting up a sensor 4 for determining the solid concentration CF of a sludge in a specific application, the appropriate model M₁-Mₙ must respectively be selected manually. In the event that the type of sludge changes over the course of time, the model M₁-Mₙ used for determining the substance concentration CF must correspondingly also be changed. If the necessity of a model change in continuous operation is not detected promptly, which often occurs, a faulty determination of the substance concentration of the sludge occurs at least intermittently.

By means of the present disclosure, a classifier K can now be used for determining a respective appropriate selected model M₂, Mₙ. The classifier K accordingly serves in principle for the intelligent recognition of the sludge type at least on the basis of the sensor signals x of the turbidity sensor 4, for example of the signals x received by means of the detector 12. Depending on the type of sludge, the classifier K selects the selected model M₂, Mₙ suitable for determining the concentration.

On the one hand, sensor signals x₁-xᵢ of the turbidity sensor 4 can serve as possible influencing variables. However, other influencing variables xⱼ, xₖ can also additionally or alternatively be provided, for example those which reflect spectral characteristics of the medium M, for example an absorption, reflection, transmission, or a scattering at one or more different wavelengths.

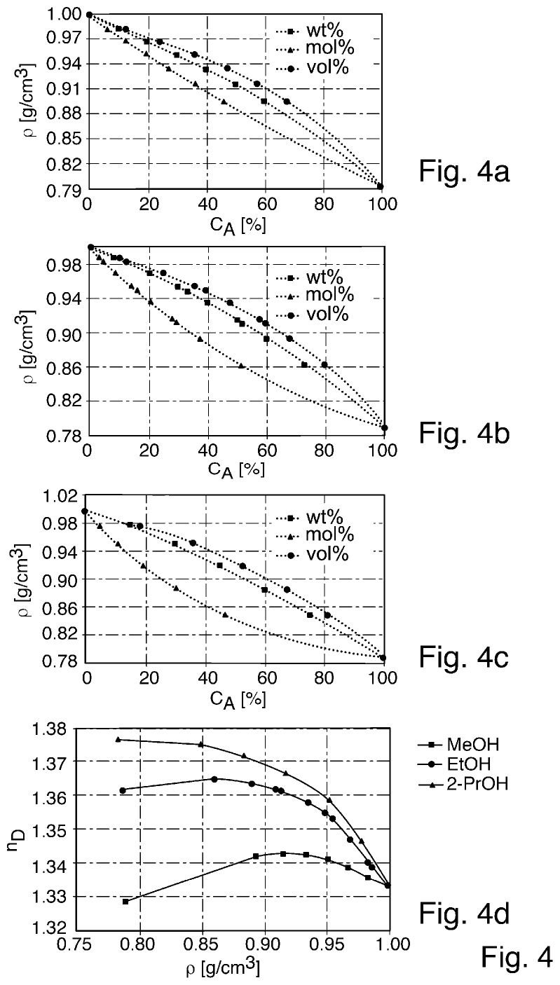

Yet another possible application of the present disclosure relates to the measurement of the alcohol content C_{A} in a medium M in the form of an aqueous solution, as illustrated in FIG. 4. The difficulty in determining the alcohol content is often that it is not known in advance what type of alcohol is involved in the respective instance, for example methanol, ethanol, or isopropanol (2-propanol). FIG. 4a-4c show characteristic curves for the different alcohols methanol (a), ethanol (b), and isopropanol (c), which indicate the density p as a function of the alcohol concentration C_{A}. The course of the characteristic curves is distinctly different for the respective alcohols. Accordingly, the accuracy in the concentration determination depends on knowing the respective alcohol present in the aqueous solution.

For example, in order to determine which alcohol is respectively involved, the density p and the refractive index n_{D} of the aqueous solution may be determined. Using these two variables, which alcohol is involved can be unambiguously determined, as can be seen from FIG. 4d. The refractive index n_{D} as a function of the density p for a particular alcohol respectively shows a characteristic curve, and is independent of the concentration of the alcohol C_{A} in the aqueous solution.

In relation to the present disclosure, the classifier K can, for example, be provided with the refractive index n_{D} and the density p of the aqueous solution as influencing variables xⱼ, xₖ. The classifier K is then designed to determine the respective alcohol present and to select a characteristic curve (the selected model M₂, Mₙ). The alcohol content C_{A} of the aqueous solution can then be determined on the basis of the characteristic curve and the density ρ.

1. A method for determining at least one process variable of a medium, including the following method steps:
recording a sensor signal from a field device;
determining a selected model from a set of at least two different models using a classifier;
wherein each of the models is used for determining the process variable at least on the basis of the sensor signal; and
wherein the classifier is designed to select the selected model; and
determining the process variable at least on the basis of the selected model and the sensor signal.

2. The method of claim 1, wherein the classifier is designed to learn the selection of the selected model.

3. The method of claim 2, wherein the classifier is trained offline or online.

4. The method of claim 1, wherein the classifier is designed to use at least one influencing variable in the selection of the selected model.

5. The method of claim 4, wherein the influencing variable is the sensor signal or a variable derived from the sensor signal.

6. The method of claim 1, wherein, based on a data record comprising at least one input variable and an output variable associated with the input variable, a mapping is created, wherein the classifier determines the selected model based on the mapping.

7. The method of claim 1, wherein a feature vector is determined, wherein the classifier is designed to select the selected model based on the feature vector.

8. The method of claim 7, wherein a first and a second classifier are used, wherein the first classifier performs a feature extraction or creates a feature vector, wherein the second classifier selects the selected model based on the feature vector.

9. The method of claim 1, further including determining a classification quality with respect to the selection of the selected model.

10. The method of claim 9, further including evaluating the classification quality using a probability with which the classifier selected the selected model.

11. The method of claim 9, further including detecting a change of the classifier from a first to a second selected model.

12. The method of claim 11, further including determining an alternating frequency between the first and the second selected models or a time interval during which the first or the second selected model is used.

13. The method of claim 1, wherein the field device is a field device for determining or monitoring a turbidity, a flow rate, or a fill level of a medium, or for determining a concentration of at least one substance contained in the medium.

14. A computer program for determining at least one process variable of a medium with computer-readable program code which, when executed on a computer, cause the computer to execute the following steps:
record a sensor signal from a field device;
determine a selected model from a set of at least two different models using a classifier;
wherein each of the models is used to determine the process variable based at least on the sensor signal; and
wherein the classifier is designed to select the selected model; and
determining the process variable at least on the basis of the selected model and the sensor signal.

15. A computer program product stored in a computer readable medium for determining at least one process variable of a medium, comprising:
computer code for recording a sensor signal from a field device;
computer code for determining a selected model from a set of at least two different models using a classifier;
wherein each of the models is used for determining the process variable at least on the basis of the sensor signal; and
wherein the classifier is designed to select the selected model; and
computer code for determining the process variable at least on the basis of the selected model and the sensor signal.
